(19) United States
(12) Patent Application Publication
(10) Pub. No.: US 2010/0096234 A1
(43) Pub. Date: Apr. 22, 2010

(54) STRUCTURE OF ONE-WAY BEARING

(76) Inventor: HUA-CHUN LIANG, Sinjhuang City (TW)

Correspondence Address: LEONG C LEI, PMB # 1008, 1867 YGNACIO VALLEY ROAD, WALNUT CREEK, CA, 94598, US

(21) Appl. No.: 12/567,823

(22) Filed: Sep. 28, 2009

(30) Foreign Application Priority Data
Oct. 22, 2008 (TW) 097218827

(51) Int. Cl. F16D 41/00

(52) U.S. Cl. 192/45

(57) ABSTRACT

A one-way bearing includes inner and outer races and balls and springs set between the races. The outer race defines accommodation chambers that respectively receives balls and springs therein in a movable manner and is composed of first and second compartments. The first compartment has a front wall surface from which a bottom wall surface extends in a radially outward direction at a given angle. The bottom wall surface extends a distance where an inward raised step is formed and connected to the second compartment. The second compartment includes a recessed space and has a configuration that includes a flange radially inboard the recessed space, and has an internal wall facing the front wall surface. The spring is retained in the second compartment for holding the ball against the front wall surface of the first compartment and the inner race to form a constraining engagement.

### (a) TECHNICAL FIELD OF THE INVENTION

The present invention generally relates to a structure of one-way bearing wherein springs are kept from long term excessive compression in order to expand the lifespan of the bearing.

### (b) DESCRIPTION OF THE PRIOR ART

A bearing is a movement enhancing device set between parts for preventing excessive abrasion between the surfaces of the parts. The bearing has wide applications. To meet the needs for various mechanical characteristics, various structures of different forms and functionalities have been developed for the bearings, among which one-way bearings provide a control function that allows for rotation in a single direction only.

Since a one-way bearing provides the function of one-way rotation, it is also referred to as a one-way clutch, of which a known example is shown in FIG. 1 of the attached drawings. The known one-way bearing, which is broadly designated at 10, comprises an outer race 12 in which a plurality of accommodation chambers 20 is defined in an equally spaced manner. Each accommodation chamber 20 is delimited by three wall surfaces 21, 22, 23 of which the first and second wall surfaces 21, 22 face each other and the third wall surface 23 faces an inner race 11 of the bearing. A rearward inclined slope 24 is provided between the first and third wall surfaces 21, 23. A spring 14 has an end supported on the second wall surface 22 and an opposite end supporting a ball 13 that is placed among the first wall surface 21, the slope 24, and an outer surface of the inner race 11. The inner race 11 forms a bore in which a working shaft 30 rides, and the outer race 12 is set in a bore defined in a part 40. When the work shaft 30 rotates in a first direction with respect to the first wall surface 21, the inner race 11 and the ball 13 are brought into contact with each other so as to impose constrain to the movement of the ball 13 to retain the ball 13 on the first wall surface 21 without further rotation, by which the rotation of the work shaft 30 is stopped. If the work shaft 30 rotates in a second, opposite direction, then due to the excessive space provided to the ball 13 by the accommodation chamber 20, the ball 13 is allowed to withdraw and separate from the inner race 11, whereby the work shaft 30 is allowed to rotate. With the ball 13 selectively set in different positions between the accommodation chamber 20 and the inner race 11, the control for one-way rotation can be realized.

Although such a known one-way bearing 10 provides an effective control for rotation in a given direction only, yet as shown in FIG. 2, during the operation of the bearing, the ball 13 is driven by the rotation of the inner race 11 to continuously and forcibly compress the spring 14. In case of high speed rotation and long term operation, the spring 14 is subjected to long term and excessive compression, making the spring 14 fatigue, whereby when the spring 14 is released from the compression, the spring 14 is unable to effectively drive the ball 13 toward the first wall surface 21 for contacting the inner race 11 to stop the rotation thereof. Thus, the bearing loses its function of one-way rotation. This is one of the major reasons that shortens the lifespan of the conventional one-way bearings and makes it necessary to frequently and uneconomically replace the bearing.

### SUMMARY OF THE INVENTION

The primary objective of the present invention is to provide a one-way bearing that prevents over-compression of springs by limiting the distance of movement of balls so as to maintain normal resiliency of the springs.

The one-way bearing provided by the present invention ensures the operation lifespan of the bearing by forming a raised step in an accommodation chamber at a location in front of a spring so that the step limits the moving distance of a ball set in the accommodation chamber thereby preventing the spring from working in a dangerous range where fatigue of the spring may occur.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional one-way bearing.

FIG. 2 is a schematic view illustrating the operation of the conventional one-way bearing.

FIG. 3 is a schematic view showing a one-way bearing according to the present invention.

FIG. 4 is a schematic view illustrating an accommodation chamber defined in the one-way bearing of the present invention.

FIG. 5 is a schematic view of the one-way bearing of the present invention, showing springs of the bearing in a condition of being compressed by balls of the bearing.

FIG. 6 is a schematic view illustrating the accommodation chamber of the bearing of the present invention for demonstrating the operation of the bearing.

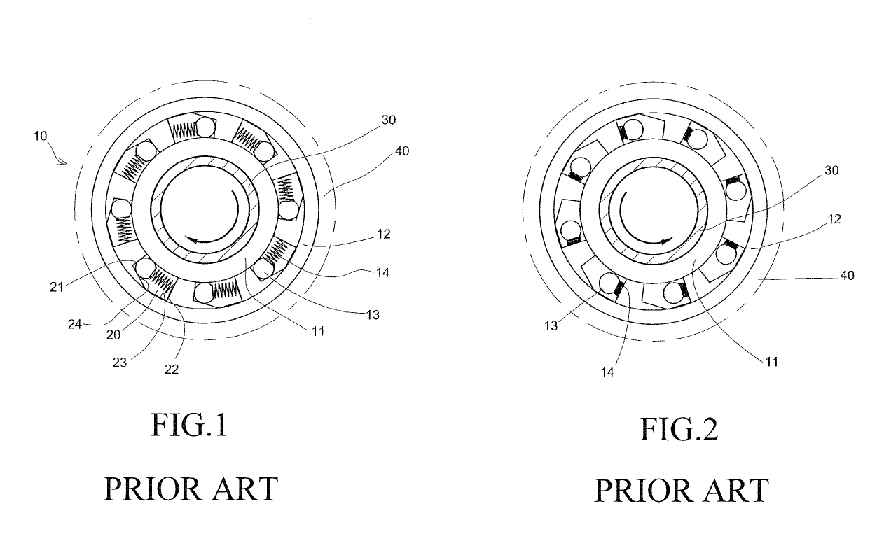

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

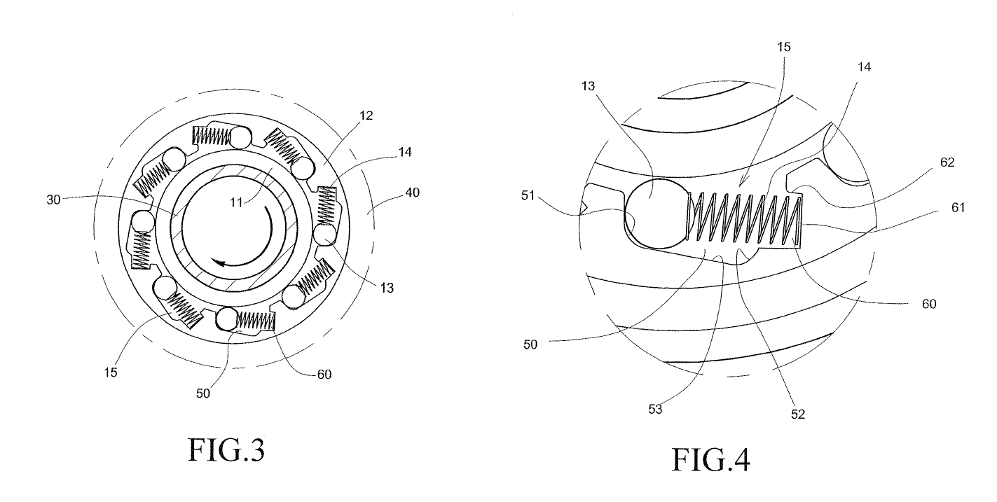

The present invention provides a structure of one-way bearing of which an embodiment is shown in FIG. 3 of the attached drawings. Similar to conventional bearings, the one-way bearing of the present invention comprises an inner race 11 and an outer race 12. The outer race 12 of the bearing of the present invention forms a plurality of accommodation chambers 15, each containing therein a ball 13 and a spring 14. The present invention is characterized in that the ball 13 is allowed to move only a limited distance for compressing the spring 14. Also referring to FIG. 4, an example of the accommodation chamber 15 is shown. The accommodation chamber 15 is composed of a first compartment 50 that contains ball 13 to accommodate the movement of the ball 13 and a second compartment 60 that contains the accommodates the deformation of the spring 14. The first compartment 50 has a front wall surface 51 from which a bottom wall surface 53 extends in a radially outward direction and faces the second compartment. The bottom wall surface 53 forms an inward raised step 52 in front of and at a distance from the second compartment 60, whereby the second compartment 60 is formed just behind the step 52.

The second chamber 60 comprises an inward recessed space having an internal wall 61 facing the front wall surface 51. The second compartment is delimited by a flange 62 circumferentially extending from the internal wall 61 for retaining the spring 14 inside the second compartment 60.

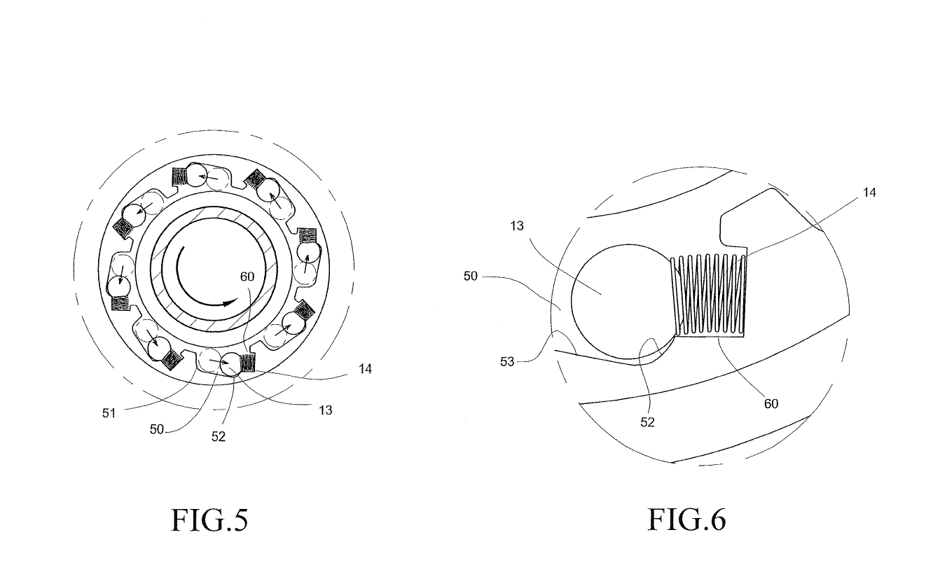

When a work shaft 30 rotates in a given direction toward the front wall surfaces 51, the balls 13 are respectively held against the front wall surfaces 51 by the springs 14, reducing the distance between the balls 13 and the inner race 12 and are thus setting the balls 13 in constraining engagement with the inner race 12, which stops the rotation of the work shaft 30. When the work shaft 30 rotates in a reversed direction, the balls 13 are caused to withdraw and at the same time compress the springs 14. Referring to FIGS. 5 and 6, due to the step 52 formed in front of the second compartment 60, when the balls 13 move along the bottom wall surfaces 53 for withdrawal and compression of the springs 14, the balls 13 are stopped by the steps 52 and are thus prevented from further compression of the spring 14. Thus, the springs 14 are protected from further and forcible compression within the second compartments 60, so as to eliminate the potential risk of spring fatigue. In this way, the springs 14 can be maintained in normal resilient condition to ensure normally driving the balls 13 toward the first compartments 50 and the lifespan of the one-way spring is expanded.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A one-way bearing comprising an inner race and an outer race, the outer race defining, in an equally spaced manner, a plurality of accommodation chambers that respectively receives balls and springs therein, wherein each accommodation chamber is composed of a first compartment and a second compartment, the first compartment having a front wall surface from which a bottom wall surface extends in a radially outward direction at a given angle, the bottom wall surface forming at an opposite end an inward raised step connected to the second compartment, the second compartment comprising a recessed space and having a configuration that comprises a flange radially inboard the recessed space, the second compartment having an internal wall facing the front wall surface, the spring being retained in the second compartment for holding the ball against the front wall surface of the first compartment and the inner race to form a constraining engagement, whereby when a work shaft rotates in a direction toward the second compartments, the balls withdraw and are stopped by the steps so that over-compression of the springs by the balls are prevented and the springs are maintained in normal resiliency.
